(19) United States
(12) Patent Application Publication
(10) Pub. No.: US 2017/0108408 A1
(43) Pub. Date: Apr. 20, 2017

(54) IN-CYLINDER PRESSURE DETECTING APPARATUS

(71) Applicants: HONDA MOTOR CO., LTD., Tokyo (JP); CITIZEN FINEDEVICE CO., LTD., Yamanashi (JP); CITIZEN HOLDINGS CO., LTD., Tokyo (JP)

(72) Inventors: Shusuke AKAZAKI, Wako-shi (JP); Kazuo TAKAHASHI, Yamanashi-ken (JP); Masanori YOMOYAMA, Yamanashi-ken (JP); Tetsuya AIBA, Yamanashi-ken (JP); Satoshi SUE, Yamanashi-ken (JP)

(21) Appl. No.: 15/278,792

(22) Filed: Sep. 28, 2016

(30) Foreign Application Priority Data
Oct. 16, 2015 (JP) 2015-204738

(51) Int. Cl. G01M 15/08; F02M 61/14; F02B 77/08; F02M 57/00

(52) U.S. Cl. CPC G01M 15/08; F02M 57/005; F02M 61/14; F02B 77/085; F02M 2200/247

(57) ABSTRACT

An in-cylinder pressure detecting apparatus for detecting a pressure in a combustion chamber of an internal combustion engine is provided. The in-cylinder pressure detecting apparatus includes a pressure detecting element mounted on a fuel injection device which injects fuel into the combustion chamber; and an amplifying circuit unit having an amplifying circuit which amplifies a signal output from the pressure detecting element and outputs a pressure detection signal. An in-cylinder pressure detecting unit including the pressure detecting element, the amplifying circuit unit, and a connecting member connecting the pressure detecting element with the amplifying circuit unit, is integrated with the fuel injection device, and an external surface of the amplifying circuit unit is shielded with metal thin film.

### BACKGROUND OF THE INVENTION

Field of the Invention

The present invention relates to an in-cylinder pressure detecting apparatus for detecting an in-cylinder pressure which is a pressure in a combustion chamber of an internal combustion engine, and particularly to the in-cylinder pressure detecting apparatus having a pressure detecting element mounted on a fuel injection device for injecting fuel into the combustion chamber.

Description of the Related Art

International Publication No. WO2012/115036 (INT'036) shows an in-cylinder pressure detecting apparatus for detecting an in-cylinder pressure using a pressure detecting element mounted on a tip-portion of a fuel injection device which injects fuel into the combustion chamber.

As shown in INT'036, in the case where the pressure detecting element is mounted on a tip-portion of the part of the fuel injection device inserted into the combustion chamber, it is preferable for suppressing influence of noises to dispose an amplifying circuit for amplifying the output signal of the pressure detecting element at a position as close as possible to the pressure detecting element. Accordingly, the inventors of the present invention contemplate employing a configuration in which the amplifying circuit is disposed at a position close to the fuel injection device. Such configuration makes it possible to shorten the connecting member for connecting the amplifying circuit to the pressure detecting element. That is, a length of the connecting member through which a low level signal, which is easily influenced by noises, passes can be shortened, thereby making it possible to reduce the influence of noises. However, the fuel injection device is a source for generating noises, and hence the configuration where the amplifying circuit is disposed close to the fuel injection device is also a factor for increasing the influence of noises to the amplifying circuit.

### SUMMARY OF THE INVENTION

The present invention was made contemplating the above-described point, and an objective of the present invention is to provide an in-cylinder pressure detecting apparatus which detects the in-cylinder pressure using the pressure detecting element mounted on the fuel injection device and makes it possible to reduce the influence of noises generated by the fuel injection device.

To attain the above objective, the present invention provides an in-cylinder pressure detecting apparatus for detecting a pressure in a combustion chamber of an internal combustion engine, the in-cylinder pressure detecting apparatus including a pressure detecting element (2) mounted on a fuel injection device (1) which injects fuel into the combustion chamber, and an amplifying circuit unit (81) having an amplifying circuit which amplifies a signal output from the pressure detecting element (2) and outputs a pressure detection signal. In the in-cylinder pressure detecting apparatus, an in-cylinder pressure detecting unit (102) including the pressure detecting element (2), the amplifying circuit unit (81), and a connecting member (12) connecting the pressure detecting element (2) with the amplifying circuit unit (81), is integrated with the fuel injection device (1), and the amplifying circuit unit (81) is shielded with metal thin film (100).

With this configuration, the in-cylinder pressure detecting unit including the pressure detecting element and the amplifying circuit unit is integrated with the fuel injection device, and the amplifying circuit unit is shielded with metal thin film. Accordingly, it is possible to reduce influence of noises generated in the fuel injection device, the influence acting on the pressure detection signal via the amplifying circuit.

Preferably, the metal thin film (100) contains metal with high magnetic permeability.

The metal thin film containing metal with high magnetic permeability makes it possible to more surely reduce influence of the electro-magnetic noises generated in the fuel injection device.

Preferably, the amplifying circuit unit (81) includes a first amplifying circuit block (41, 42) for detecting the in-cylinder pressure within a relatively high pressure range, and a second amplifying circuit block (44, 45) for detecting the in-cylinder pressure within a relatively low pressure range, wherein the second amplifying circuit block includes a low pass filter (45) or a band pass filter.

With this configuration, the noises contained in the pressure detection signal can be reduced by the low pass filter or the band pass filter in the second amplifying circuit block, which makes it possible to effectively reduce the noises in the relatively low pressure range where the influence of the noises becomes relatively large. If the low pass filter or the band pass filter is disposed in the first amplifying circuit block for detecting the relatively high pressure range where the in-cylinder pressure is relatively high, detection of the knocking signal comprising comparatively high frequency components becomes impossible. On the other hand, in the relatively low pressure range where the in-cylinder pressure is relatively low, changes in the in-cylinder pressure are relatively small. Accordingly, disposing the low pass filter or the band pass filter in the second amplifying circuit block makes it possible to effectively reduce the influence of noises, with avoiding the bad influence in the range where the in-cylinder pressure largely changes.

Preferably, the in-cylinder pressure detecting further includes failure detecting means for performing failure detection by comparing a high side in-cylinder pressure (PCYLH) based on the pressure detection signal (SDETH) output from the first amplifying circuit block (42, 43), with a low side in-cylinder pressure (PCYLL) based on the pressure detection signal (SDETL) output from the second amplifying circuit block (44, 45).

With this configuration, comparison between the high side in-cylinder pressure based on the pressure detection signal output from the first amplifying block and the low side in-cylinder pressure based on the pressure detection signal output from the second amplifying block, can be performed, both of the high side in-cylinder pressure and the low side in-cylinder pressure corresponding to the same detection timing. Accordingly, it is possible to determine that a failure has occurred in the first or second amplifying circuit block, if a ratio between the high side in-cylinder pressure and the low side in-cylinder pressure is outside the allowable range, for example.

Preferably, the in-cylinder pressure detecting apparatus further includes control operation means which selects one of the high side in-cylinder pressure (PCYLH) and the low side in-cylinder pressure (PCYLL) respectively based on the pressure detection signals (SDETH,SDETL) output from the first and second amplifying circuit blocks, wherein the control operation means uses the selected one of the high side in-cylinder pressure and the low side in-cylinder pressure for calculating an output torque of the engine and/or an amount of heat generated in the combustion chamber.

With this configuration, one of the high side in-cylinder pressure and the low side in-cylinder pressure respectively based on the pressure detection signals output from the first and second amplifying circuit blocks, is selected, and the selected one is used for calculating an output torque of the engine and/or an amount of heat generated in the combustion chamber. By using the detected in-cylinder pressure suitable to the calculation, detection accuracy of the in-cylinder pressure especially in the relatively low pressure range can be enhanced, thereby improving calculation accuracy of the output torque and/or the generated heat amount.

Preferably, the control operation means selects the high side in-cylinder pressure (PCYLH) during the compression stroke and the expansion stroke of a cylinder on which the fuel injection device is mounted, while the control operation means selects the low side in-cylinder pressure (PCYLL) during the intake stroke and the exhaust stroke of the cylinder.

With this configuration, the high side in-cylinder pressure is selected during the compression stroke and the expansion stroke of the cylinder on which the fuel injection device is mounted, while the low side in-cylinder pressure is selected during the intake stroke and the exhaust stroke of the cylinder. Accordingly, the detected in-cylinder pressure suitable to calculating the output torque and/or the generated heat amount is selected so as to enhance detection accuracy of the in-cylinder pressure especially in the relatively low pressure range, thereby improving calculation accuracy of the output torque and/or the generated heat amount.

Preferably, the control operation means selects the high side in-cylinder pressure (PCYLH) when the high side in-cylinder pressure (PCYLH) is higher than a predetermined pressure (PCYLTH), while the control operation means selects the low side in-cylinder pressure (PCYLL) when the high side in-cylinder pressure (PCYLH) is equal to or lower than the predetermined pressure (PCYLTH).

With this configuration, the high side in-cylinder pressure is selected when the high side in-cylinder pressure is higher than a predetermined pressure, while the low side in-cylinder pressure is selected when the high side in-cylinder pressure is equal to or lower than the predetermined pressure. Accordingly, the detected in-cylinder pressure suitable to calculating the output torque and/or the generated heat amount is selected so as to enhance detection accuracy of the in-cylinder pressure especially in the relatively low pressure range, thereby improving calculation accuracy of the output torque and/or the generated heat amount.

Preferably, the control operation means selects the high side in-cylinder pressure (PCYLH) when a rotation angle of a crankshaft of the engine is within a preset range (CA1-CA2), while the control operation means selects the low side in-cylinder pressure (PCYLL) when the rotation angle of the crankshaft is outside the preset range.

With this configuration, the high side in-cylinder pressure is selected when the rotation angle of the crankshaft is within the preset range, while the low side in-cylinder pressure is selected when the rotation angle of the crankshaft is outside the preset range. For example, by setting the preset range as an angle range which contains the compression stroke and the expansion stroke of the object cylinder, and is slightly wider than the two strokes, the detected in-cylinder pressure suitable to calculating the output torque and/or the generated heat amount is selected to enhance detection accuracy of the in-cylinder pressure especially in the relatively low pressure range, thereby improving calculation accuracy of the output torque and/or the generated heat amount. In addition, if the engine has a mechanism for changing an operation phase of the intake valve and/or the exhaust valve, it is possible, by changing the preset range in response to the change in the operation phase of the intake valve and/or the exhaust valve, to accurately perform the above calculation even when the operation phase of the intake valve and/or the exhaust valve is/are changed.

### BRIEF DESCRIPTION OF THE DRAWINGS

FIGS. 1A-1C are drawings for illustrating a configuration of an in-cylinder pressure detecting unit integrated fuel injection device according to one embodiment of the present invention;

FIGS. 2A and 2B are drawings for illustrating a configuration of the in-cylinder pressure detecting unit shown in FIGS. 1A-1C;

FIGS. 3A and 3B are drawings for illustrating a structure of the connecting member (12) shown in FIG. 1A;

FIG. 4 is a sectional view showing a structure near a tip-portion of the in-cylinder pressure detecting unit integrated fuel injection device;

FIG. 5 is a block diagram showing a configuration of the amplifying circuit unit shown in FIG. 1A;

FIG. 6 is a drawing for illustrating connection between the connector pins (21-23) shown in FIGS. 1A and 1C, and an electronic control unit;

FIG. 7 shows a relationship between a detected in-cylinder pressure (PCYL) and a voltage level (VDET) of the pressure detection signals (SDETH, SDETL) output from first and second amplifying circuit blocks;

FIGS. 8A and 8B show changes in a high side in-cylinder pressure (PCYLH) and a low side in-cylinder pressure (PCYLL) based on the detection signals output from the first and second amplifying circuit blocks;

FIGS. 9A-9E show drawings for illustrating methods for selecting one of the high side in-cylinder pressure (PCYLH) and the low side in-cylinder pressure (PCYLL);

FIGS. 10A-10C show flowcharts of the selection processes corresponding to the first to third selection method shown in FIGS. 9C-9E; and

FIG. 11 is a flowchart of a process for performing a failure detection.

### DETAILED DESCRIPTION OF THE PREFERRED EMBODIMENTS

Preferred embodiments of the present invention will now be described with reference to the drawings.

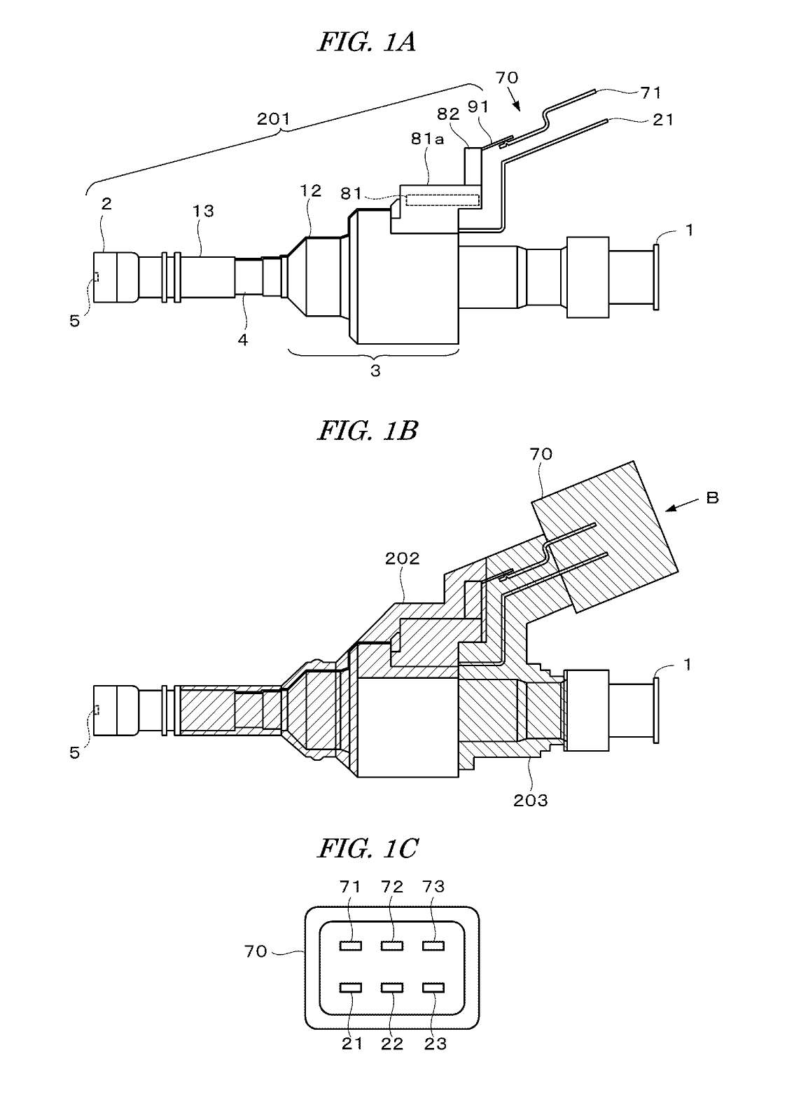

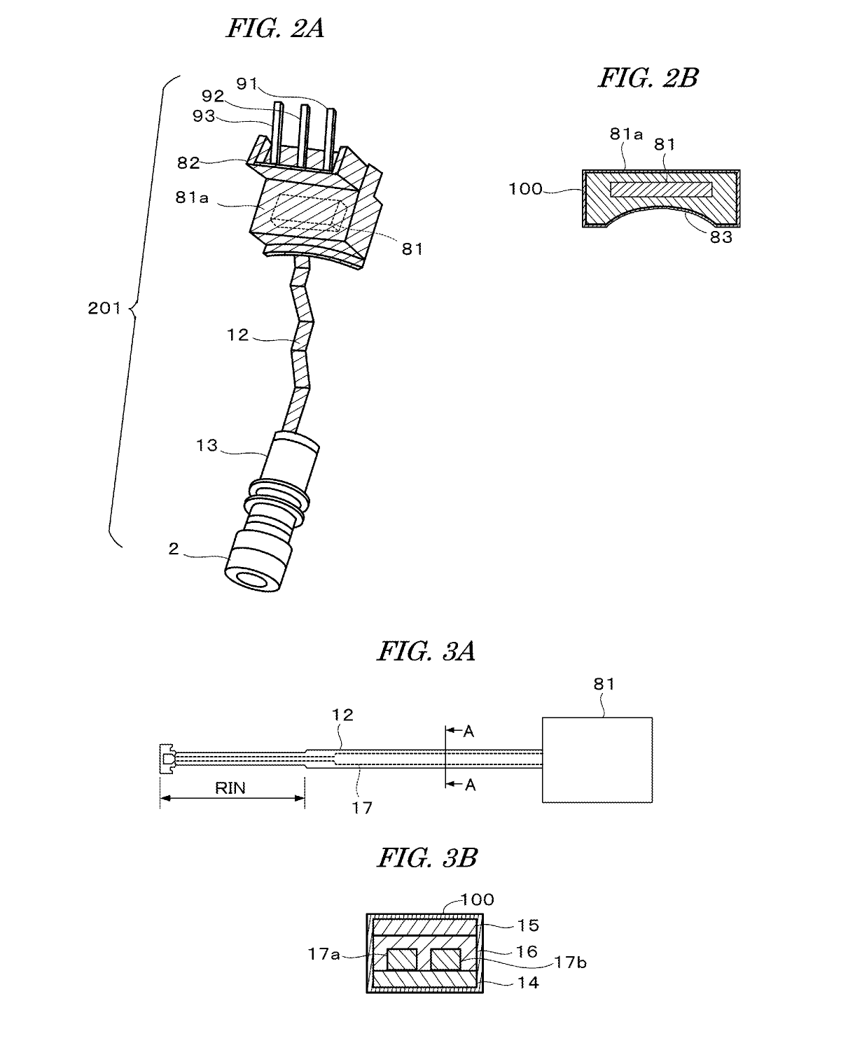

FIG. 1A shows a side view of an in-cylinder pressure detecting unit integrated fuel injection device in this embodiment, FIG. 1B is a drawing for illustrating a state where synthetic resin mold is covered on the fuel injection device shown in FIG. 1A, and FIG. 1C is a drawing for explaining a main-body connector block 70 viewed from the direction indicated with the arrow B in FIG. 1B. FIG. 1A shows, for explanation, a state where no synthetic resin mold is covered (it is to be noted that regarding an amplifying circuit unit 81, a state where the amplifying circuit unit 81 is sealing-molded with synthetic resin mold 81a, is shown). FIGS. 2A and 2B are drawings for illustrating a configuration of the in-cylinder pressure detecting unit 201 before being integrated with the fuel injection device.

The fuel injection device 1 is a device for injecting fuel into a combustion chamber of the internal combustion engine. The fuel injection device 1 includes well-known structural elements such as a valve shaft, a solenoid (actuating circuit) for actuating the valve shaft, and a spring for energizing the valve shaft. The fuel injection device 1 is mounted on a cylinder of the internal combustion engine so that an injection port 5 disposed at the tip-portion is exposed in the combustion chamber, and injects fuel from the injection port 5 into the combustion chamber. The fuel injection device 1 has a large diameter casing 3 made of metal and a small diameter casing 4 made of metal. The large diameter casing 3 contains the solenoid, and the tip-portion of the small diameter casing 4 is provided with the injection port 5. It is to be noted that the large diameter casing 3 includes all portions having diameters larger than that of the small diameter casing 4.

The in-cylinder pressure detecting unit 201 is configured by previously assembling a pressure detecting element 2, a sensor fixing member 13 having a cylindrical shape on which the pressure detecting element 2 is fixed at a tip-portion thereof, the amplifying circuit unit 81, and a connecting member 12 connecting the pressure detecting element 2 with the amplifying circuit unit 81. The in-cylinder pressure detecting unit 201 is mounted on the fuel injection device 1 by fitting the sensor fixing member 13 onto the tip-portion side (injection port 5 side) of the small diameter casing 4. Accordingly, the pressure detecting element 2 is mounted at the tip-portion (a position such that the pressure detecting element 2 surrounds the injection port 5) of the fuel injection device 1, and connected via the connecting member 12 to the amplifying circuit unit 81. The amplifying circuit unit 81 is covered (sealing-molded) with the synthetic resin mold 81a having heat resistance. Sub-connector pins 91-93 are fixed on the amplifying circuit unit 81, and a sub-connector block 82 including the sub-connector pins 91-93 is formed with the synthetic resin mold a.

FIG. 2A is a perspective view of the in-cylinder pressure detecting unit 201, and FIG. 2B is a cross-sectional view of the synthetic resin mold 81a (the portion containing the amplifying circuit unit 81). The synthetic resin mold 81a has a curved bottom surface 83, and the in-cylinder pressure detecting unit 201 is mounted so that the bottom surface 83 contacts the outer surface of the large diameter casing 3. In this embodiment, the portions with hatchings, i.e., all surfaces of the synthetic resin mold 81a (including a part of the sub-connector block 82 other than the sub-connector pins 91-93) and the connecting member 12 (including the surface positioned on the back side in FIG. 2A, refer to FIG. 2B and FIG. 3B), are covered (shielded) with a metal thin film 100.

The thickness of the metal thin film 100 is about 20 μm, and for example, silver is used as a material for the metal thin film 100. Specifically, the metal thin film 100 is formed by coating the object members with silver paste. It is preferable to form the metal thin film 100 using alloy containing metal with high magnetic permeability, such as iron or nickel in addition to silver. Using alloy containing the metal with high magnetic permeability makes it possible to more surely reduce the influence of the electro-magnetic noises generated in the fuel injection device 1. By integrating the in-cylinder pressure detecting unit 201 with the fuel injection device 1, the metal thin film 100 contacts the large diameter portion 3 to be electrically conducted to the fuel injection device 1. Further, by mounting the fuel injection device 1 on the internal combustion engine, the casing of the fuel injection device 1 including the large diameter portion 3 and the small diameter portion 4 is electrically conducted to the cylinder head of the internal combustion engine.

The main-body connector block 70 configured with a part of the synthetic resin mold 203 is fixed on the fuel injection device 1, and connecting wires from an electronic control unit (hereinafter referred to as “ECU”) 60 (refer to FIGS. 5 and 6) are connected to the main-body connector block 70. The ECU 60 performs operations such as actuation control of the fuel injection device 1, detection of an in-cylinder pressure PCYL using the in-cylinder pressure detecting unit 201, calculation of the engine output torque using the detected in-cylinder pressure PCYL, and detection of knocking.

As shown in FIG. 1C, the main-body connector block 70 is provided with first connector pins 21-23 and second connector pins 71-73. Actuation signal wires for supplying an actuation signal of the fuel injection device 1 from the ECU 60 are connected to the first connector pins 21-23. Wires such as a detection signal wire for supplying a pressure detection signal to the ECU 60, a power source connection wire, and a ground connection wire, are connected to the second connector pins 71-73. The second connector pins 71-73 are connected to the sub-connector pins 91-93 in the main-body connector block 70.

A connector member (not shown) which can be fitted onto the first connector pins 21-23 and the second connector pins 71-73 is fixed at an end-portion of connecting wires from the ECU 60. The connector member is fitted onto the main-body connector block 70, thereby connecting the connecting wires to the connector pins 21-23 and 71-73.

The amplifying circuit unit 81 covered with the synthetic resin mold 81a, the connecting member 12, and a part (near the amplifying circuit unit 81) of the sensor fixing member 13 are covered with the synthetic resin mold 202 after integrating the in-cylinder pressure detecting unit 201 with the fuel injection device 1 (refer to FIG. 1B). The sub-connector pins 91-93 are resistance-welded respectively with the second connector pins 71-73 after integrating the in-cylinder pressure detecting unit 201 with the fuel injection device 1 and before covering with the synthetic resin mold 202.

In FIG. 1B, the portion with hatchings falling rightward corresponds to the synthetic resin mold 203 constituting the main-body connector block 70 of the fuel injection device 1, and the portion with hatchings rising rightward corresponds to the synthetic resin mold 202 which is finally molded.

FIGS. 3A and 3B show diagrams for illustrating a structure of the connecting member 12. FIG. 3A is a plane view and FIG. 3B is a sectional view of the A-A line indicated in FIG. 3A. The connecting member 12 is configured by covering copper wires 17a and 17b with adhesive 16 (epoxy resin) and coating members 14 and 15 made of polyimide. The structure of the connecting member 12 is known as a flexible printed wiring board, and hence the connecting member 12 is easily foldable without causing disconnection of wires. The copper wire 17a is used for transmitting the output signal of the pressure detecting element 2 and the copper wire 17b is used as a grounding wire.

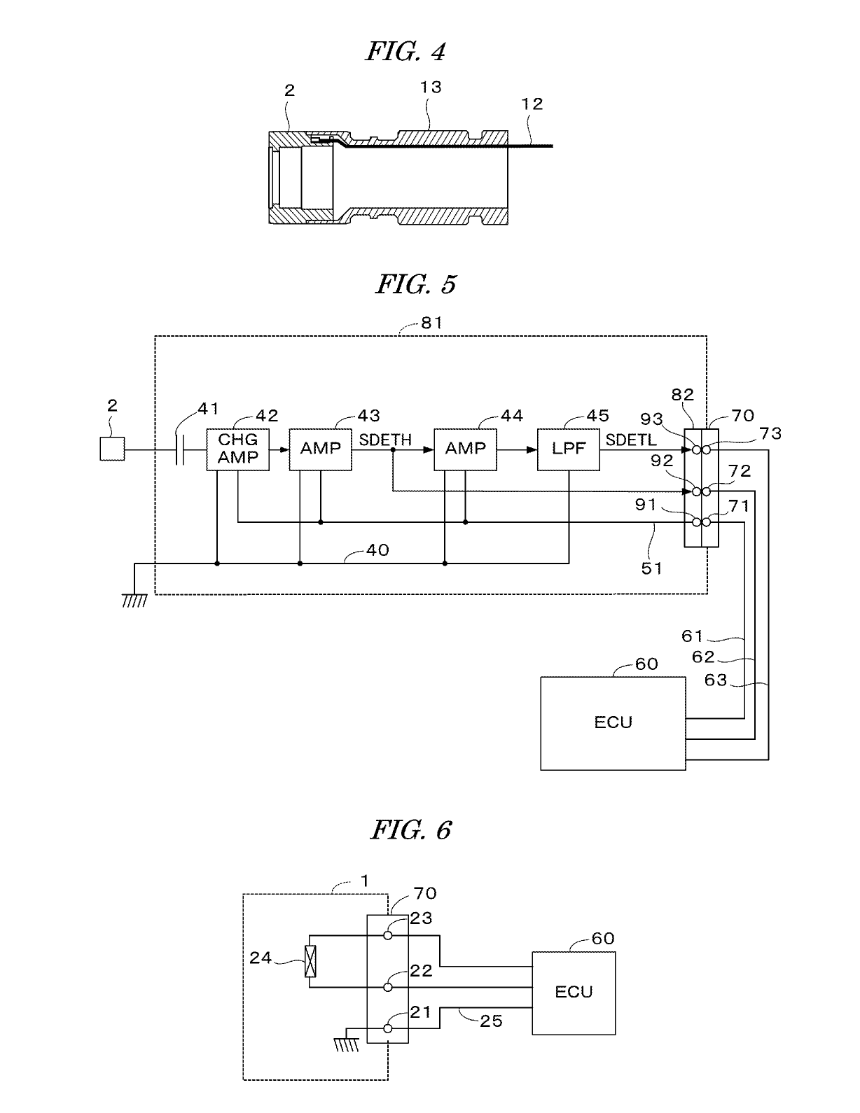

Further, in this embodiment, all surfaces of the connecting member 12 are covered with the metal thin film 100. It is to be noted that the thickness of components 14-17a, 17b, and the metal thin film 100 shown in FIG. 3B is, for explanation, drawn more largely than the actual thickness. The connecting member 12 is arranged so that the vicinity of the end-portion connected to the pressure detecting element 2 (the portion indicated with RIN in FIG. 3A) passes through inside of the sensor fixing member 13 made of metal as shown in FIG. 4, and a portion between the portion indicated with RIN and the amplifying circuit unit 81 passes along the external surfaces of the small diameter casing 4 and the large diameter casing 3 of the fuel injection device 1.

FIG. 5 is a block diagram showing a configuration of the amplifying circuit unit 81. The amplifying circuit unit 81 includes a capacitor 41, a charge amplifier 42, a first amplifying circuit 43, a second amplifying circuit 44, a low pass filter 45, and the sub-connector pins 91-93 constituting the sub-connector block 82. A direct-current power source voltage (e.g., 5V) is supplied to the sub-connector pin 91 via the main-body connector block 70 (connector pin 71) and a power source connection wire 61. The sub-connector pins 92 and 93 are connected respectively to two AD converters (not shown) in the ECU 60 via the main-body connector block 70 (connector pins 72 and 73) and signal connection wires 62 and 63.

The power source line 51 connected to the sub-connector pin 91 is connected to the charge amplifier 42, the first amplifying circuit 43, and the second amplifying circuit 44. The ground line 40 of the amplifying circuit unit 81 is connected to the casing of the fuel injection device 1. The sub-connector pin 92 is connected to the output of the first amplifying circuit 43, and a high side pressure detection signal SDETH is supplied to the ECU 60 via the sub-connector pin 92 and the signal connection wire 62. The sub-connector pin 93 is connected to the output of the low pass filter 45, and a low side pressure detection signal SDETL is supplied to the ECU 60 via the sub-connector pin 93 and the signal connection wire 63.

The ECU 60 converts the high side pressure detection signal SDETH and the low side pressure detection signal SDETL respectively to digital signal values (a high side in-cylinder pressure PCYLH and a low side in-cylinder pressure PCYLL) with the two AD converters, and performs the calculation described later.

The capacitor 41 cuts the direct-current component contained in the detection signal input through the connecting member 12 from the pressure detecting element 2, and only alternating-current components are input to the charge amplifier 42. The charge amplifier 42 converts the input signal indicative of a pressure change rate to a pressure detection signal indicative of a pressure value by integrating and amplifying the input signal. The second amplifying circuit 44 amplifies the high side pressure detection signal SDETH by a gain of about 7.5 times. The low pass filter 45 eliminates fuel injection noises caused by operation of the fuel injection device 1. The cut-off frequency of the low pass filter 45 is set to a frequency capable of reducing the fuel injection noises (e.g., about 500 Hz).

FIG. 6 is a drawing for illustrating connection of the first connector pins 21-23. Both ends of the actuation solenoid 24 in the fuel injection device 1 are connected to the ECU 60 via the first connector pins 22 and 23 of the main-body connector block 70. The first connector pin 21 is connected to the ground of the ECU 60 via a ground connecting wire 25 and is also connected to the casing of the fuel injection device 1. The ground connection wire 25 (the first connector pin 21) functions as the ground (ground for the pressure detecting element 2) for the pressure detection signals SDETH and SDETL based on the detection signal output from the pressure detecting element 2. The ground connection wire 25 is insulated from the first connector pins 22 and 23.

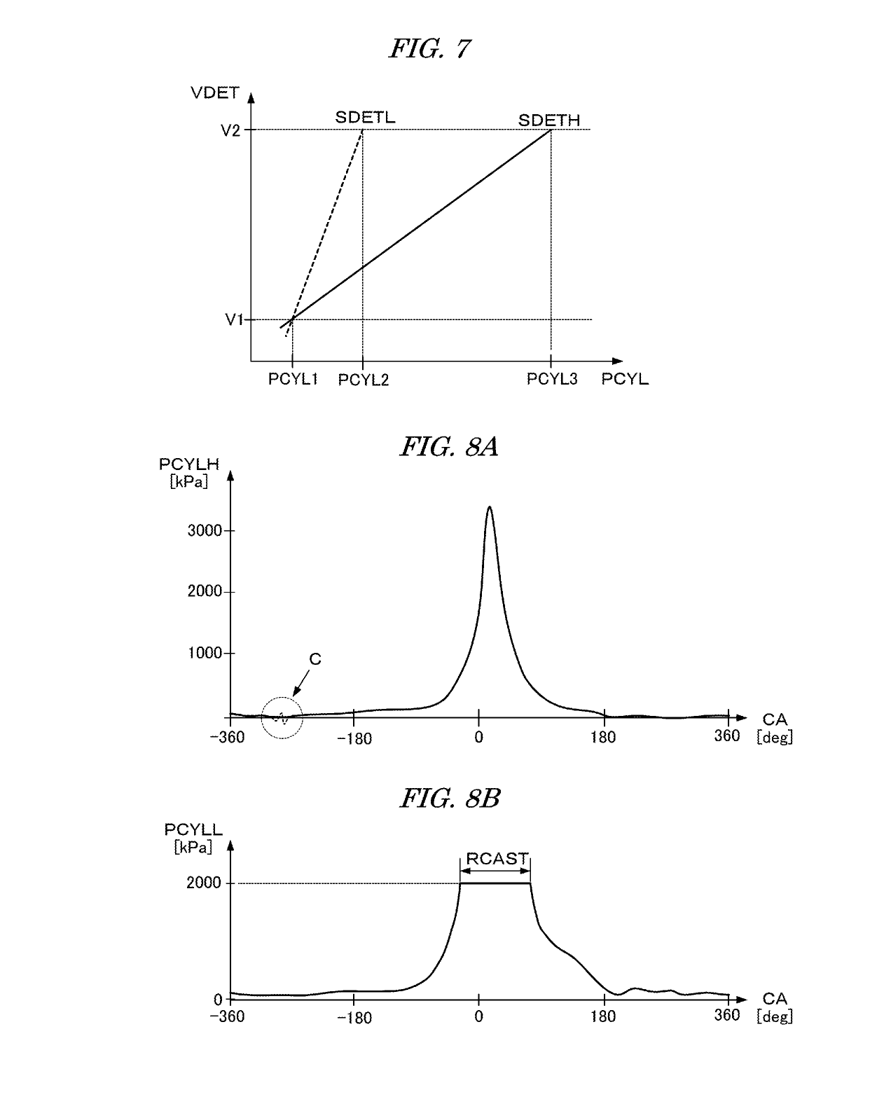

FIG. 7 shows a relationship between the in-cylinder pressure PCYL and a voltage level VDET of the high side pressure detection signal SDETH and the low side pressure detection signal SDETL. In FIG. 7, the solid line corresponds to the high side pressure detection signal SDETH, and the broken line corresponds to the low side pressure detection signal SDETL. In FIG. 7, PCYL1 and PCYL2 correspond respectively to the atmospheric pressure (100 kPa) and a pressure value of about 15000 kPa, V1 and V2 correspond respectively to voltage values of about 0.9 V and 5.0 V. Specifically, the low side pressure detection signal SDETL is amplified by the gain of the second amplifying circuit 44 compared with the high side pressure detection signal SDETH, and hence the inclination of the broken line is larger than that of the solid line.

FIGS. 8A and 8B show changes in the detected in-cylinder pressure (the horizontal axis indicates the crank angle CA and “0” degree corresponds to the compression stroke end angle). FIG. 8A corresponds to the high side in-cylinder pressure PCYLH obtained from the high side pressure detection signal SDETH, and FIG. 8B corresponds to the low side in-cylinder pressure PCYLL obtained from the low side pressure detection signal SDETH. In FIG. 8A, the fuel injection noise caused by the fuel injecting operation of the fuel injection device 1 is indicated by the broken line at the portion surrounded by the circle indicated with “C” (the portion in the vicinity of −270 degrees of the crank angle CA). The fuel injection noise enters the pressure detection signal if the amplifying circuit unit 81 is not shielded with the metal thin film 100.

In this embodiment, the connecting member 12, the amplifying circuit unit 81, and the synthetic resin mold 81a (including surfaces of the sub-connector block 82 other than the connector pins) are shielded with the metal thin film 100, which makes it possible to remove or reduce the fuel injection noise shown by the broken line. Further, since the fuel injection noise contained in the low side pressure detection signal SDETL is eliminated by the low pass filter 45, the fuel injection noise is completely removed from the low side pressure in-cylinder pressure PCYLL which is shown as the enlarged wave form in FIG. 8B.

As clear from FIGS. 8A and 8B, the high side in-cylinder pressure PCYLH indicates pressure values from a low in-cylinder pressure to the maximum in-cylinder pressure, and the low side in-cylinder pressure PCYLL indicates the low pressure values lower than a pressure value of about 2000 kPa with high accuracy, although the low side in-cylinder pressure PCYLL saturates in the crank angle range RCAST since the amplifying gain of the low side pressure detection signal SDETL is increased by the second amplifying circuit 44. Accordingly, in this embodiment, the calculation required for the control (e.g., calculation of the output torque of the internal combustion engine, or calculation of an amount of heat generated in the object cylinder) is performed using the low side in-cylinder pressure PCYLL in the crank angle range where the in-cylinder pressure PCYL is relatively low, while the calculation required for the control (including detection of knocking) is performed using the high side in-cylinder pressure PCYLH in the crank angle range where the in-cylinder pressure PCYL is relatively high.

For example, when calculating the output torque TRQ of the engine, the net indicated mean effective pressure NMEP is calculated by adding the indicated mean effective pressure IMEP in the compression stroke and the expansion stroke and the indicated mean effective pressure PMEP (negative value) in the intake stroke and the exhaust stroke, and the output torque is calculated using the net indicated mean effective pressure NMEP. Accordingly, by removing influence of the noise which enters the pressure detection signal during the intake stroke as shown by the broken line in FIG. 8A, the indicated mean effective pressure PMEP can be calculated with high accuracy. Consequently, it is possible to accurately calculate the net indicated mean effective pressure NMEP, thereby enhancing calculation accuracy of the engine output torque TRQ.

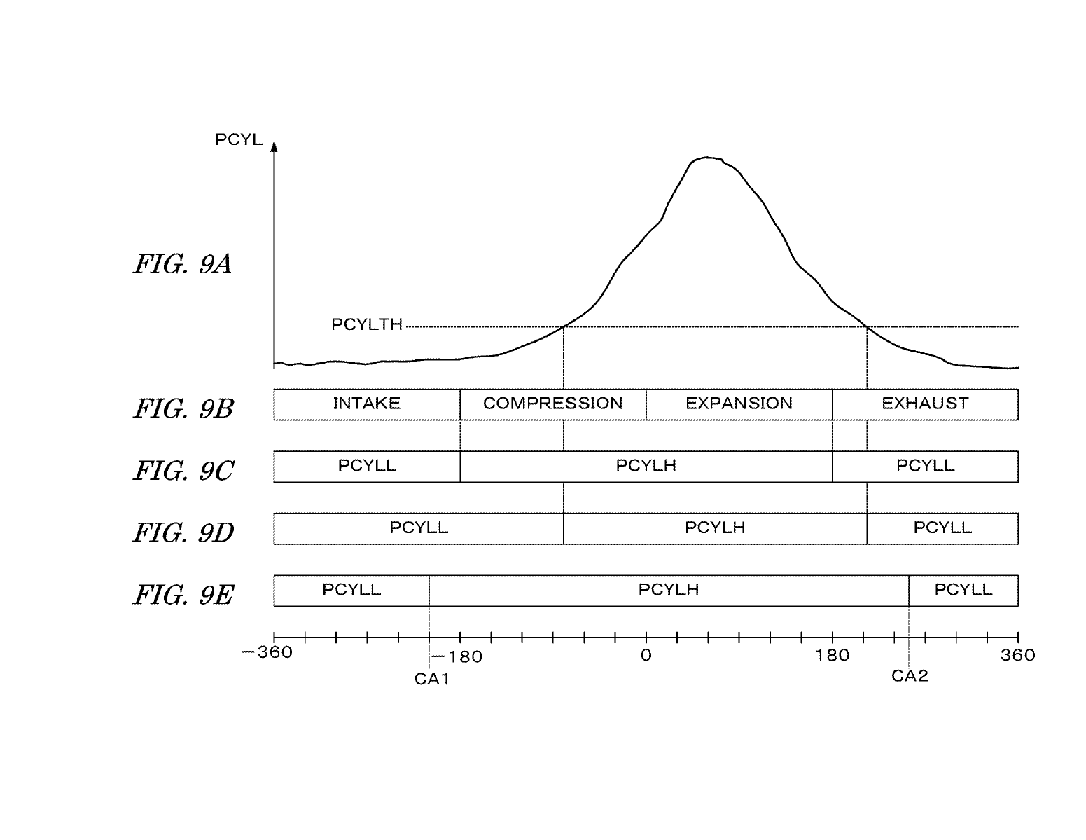

FIGS. 9A-9E show drawings for illustrating which one of the high side in-cylinder pressure PCYLH and the low side in-cylinder pressure PCYLL is selected and applied to calculations such as the output torque calculation (i.e., drawings for illustrating selecting methods). FIGS. 9A-9E respectively show changes in the in-cylinder pressure PCYL, the strokes of the object cylinder, the selection by a first selecting method, the selection by a second selecting method, and the selection by a third selecting method.

Specifically, in the first selecting method, the high side in-cylinder pressure PCYLH is selected in the compression stroke and the expansion stroke of the object cylinder, and the low side in-cylinder pressure PCYLL is selected in the intake stroke and the exhaust stroke. In the second selecting method, the high side in-cylinder pressure PCYLH is selected when the high side in-cylinder pressure PCYLH is higher than a predetermined pressure PCYLTH (which is set to a pressure value that is slightly lower than the pressure value at which the low side in-cylinder pressure saturates, e.g., 1900 kPa), and the low side in-cylinder pressure PCYLL is selected when the high side in-cylinder pressure PCYLH is equal to or lower than the predetermined pressure PCYLTH. In the third selecting method, the high side in-cylinder pressure PCYLH is selected within a preset crank angle range where the crank angle CA is greater than a first crank angle CA1 (e.g., −210 degrees) and less than a second crank angle CA2 (e.g., 255 degrees), and the low side in-cylinder pressure PCYLL is selected outside the preset crank angle range (within the range from −360 degrees to CA1, and the range from CA2 to 360 degrees). The preset crank angle range is set to a range which is wider than the angle range RCAST shown in FIG. 8B, and includes the angle range RCAST.

With respect to an internal combustion engine having a mechanism for changing an operation phase of the intake valve and/or the exhaust valve, it is preferable to employ the third selecting method. According to the third selecting method, the preset crank angle range can be changed in response to the change in the operation phase of the intake valve and/or the exhaust valve, thereby accurately performing the above-described calculation even when the operation phase of the intake valve and/or the exhaust valve is/are changed.

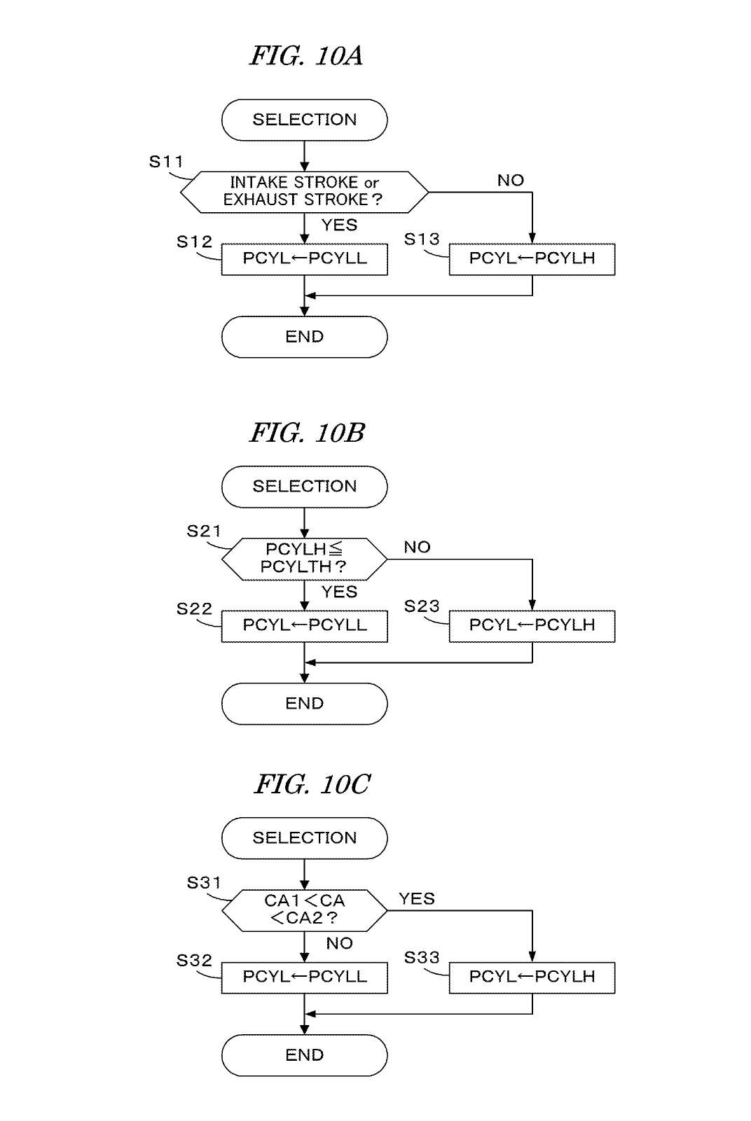

FIGS. 10A-10C are flowcharts of the processes respectively corresponding to the above-described first, second, and third selecting method for selecting one of the high side in-cylinder pressure PCYLH and the low side in-cylinder pressure PCYLL. The processes are executed at predetermined crank angle intervals.

In the process of FIG. 10A, it is determined whether or not the object cylinder is in the exhaust stroke or the intake stroke (step S11). If the answer to step S11 is affirmative (YES), the in-cylinder pressure PCYL is set to the low side in-cylinder pressure PCYLL (step S12). If the answer to step S11 is negative (NO), that is, in the compression stroke or the expansion stroke, the in-cylinder pressure PCYL is set to the high side in-cylinder pressure PCYLH (step S13).

In the process of FIG. 10B, it is determined whether or not the high side in-cylinder pressure PCYLH is equal to or lower than the predetermined pressure PCYLTH (step S21). If the answer to step S21 is affirmative (YES), the in-cylinder pressure PCYL is set to the low side in-cylinder pressure PCYLL (step S22). If the answer to step S21 is negative (NO), that is, the high side in-cylinder pressure PCYLH is higher than the predetermined pressure PCYLTH, the in-cylinder pressure PCYL is set to the high side in-cylinder pressure PCYLH (step S23).

In the process of FIG. 10C, it is determined whether or not the crank angle CA detected by the crank angle sensor (not shown) is greater than the first crank angle CA1 and less than the second crank angle CA2 (step S31). If the answer to step S31 is affirmative (YES), the in-cylinder pressure PCYL is set to the high side in-cylinder pressure PCYLH (step S33). If the answer to step S31 is negative (NO), that is, the crank angle CA is in the range from −360 degrees to the first crank angle CA1, or in the range from the second crank angle CA2 to 360 degrees, the in-cylinder pressure PCYL is set to the low side in-cylinder pressure PCYLL (step S32).

The in-cylinder pressure PCYL, which is set to one of the high side in-cylinder pressure PCYLH and the low side in-cylinder pressure PCYLL, is applied to the calculation of the output torque of the internal combustion engine, and/or the calculation of an amount of heat generated in the combustion chamber.

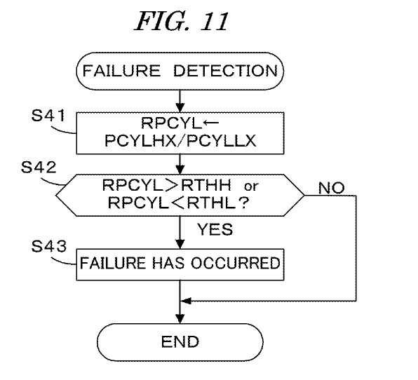

FIG. 11 is a flowchart of a failure detecting process. This process is executed by the ECU 60 once in one combustion cycle of the object cylinder.

In step S41, an in-cylinder pressure ratio RPCYL (=PCYLHX/PCYLLX) is calculated, the in-cylinder pressure ratio RPCYL being a ratio of a high side determination in-cylinder pressure PCYLHX and a low side determination in-cylinder pressure PCYLLX. The high side determination in-cylinder pressure PCYLHX indicates an in-cylinder pressure at a timing when the crank angle CA is equal to a predetermined crank angle CAFD (e.g., a timing of −120 degrees which means 120 degrees before the compression stroke end top dead center of the object cylinder), and the low side determination in-cylinder pressure PCYLLX indicates the in-cylinder pressure at the same timing.

In step S42, it is determined whether or not the in-cylinder pressure ratio RPCYL is greater than an upper threshold value RTHH (e.g., 1.2) or less than a lower threshold value RTHL (e.g., 0.8). If the answer to step S42 is negative (NO), that is, the in-cylinder pressure ratio RPCYL is equal to or less than the upper threshold value RTHH and equal to or greater than the lower threshold value RTHL, the process immediately ends. If the answer to step S42 is affirmative (YES), it is determined that a failure has occurred (step S43).

The predetermined crank angle CAFD is set within an angle range other than the crank angle range RCAST where the low side in-cylinder pressure PCYLL saturates. If no failure has occurred, the high side determination in-cylinder pressure PCYLHX is substantially equal to the low side determination in-cylinder pressure PCYLLX. Accordingly, if the in-cylinder pressure ratio RPCYL is greater than the upper threshold value RTHH, or less than the lower threshold value RTHL, it is possible to determine that a failure (e.g., a failure of the second amplifying circuit 44) has occurred.

As described above, in this embodiment, the in-cylinder pressure detecting unit 201 including the pressure detecting element 2 and the amplifying circuit unit 81 is integrated with the fuel injection device 1, and all surfaces of the connecting member 12, the amplifying circuit unit 81, and the synthetic resin mold 81a (including a part of the sub-connector block 82 other than the sub-connector pins 91-93) are shielded with the metal thin film 100. Accordingly, it is possible to reduce influence of noises generated in the fuel injection device 1, the influence acting on the pressure detection signal via the amplifying circuit unit 81.

Further, in the second amplifying circuit block comprising the second amplifying circuit 44 and the low pass filter 45, the noises contained the pressure detection signal are removed or reduced by the low pass filter 45, which makes it possible to effectively reduce the noises in the relatively low pressure range where the influence of the noises becomes relatively large. If the low pass filter or a band pass filter is disposed in the first amplifying circuit block (comprising the charge amplifier 42 and the first amplifying circuit 43 in this embodiment) for detecting the relatively high pressure range where the in-cylinder pressure is relatively high, detection of the knocking signal comprising comparatively high frequency components (e.g., 13 kHz) becomes impossible. On the other hand, in the relatively low pressure range where the in-cylinder pressure PCYL is relatively low, changes in the in-cylinder pressure PCYL are relatively small (the time change rate of the in-cylinder pressure PCYL is relatively small). Accordingly, disposing the low pass filter 45 in the second amplifying circuit block makes it possible to effectively reduce the influence of noises, avoiding the bad influence in the range where the in-cylinder pressure PCYL largely changes.

Further, the high side in-cylinder pressure PCYLH and the low side in-cylinder pressure PCYLL are obtained by respectively converting the high side pressure detection signal SDETH output from the first amplifying circuit block and the low side pressure detection signal SDETHL output from the second amplifying circuit block, to digital values. One of the high side in-cylinder pressure PCYLH and the low side in-cylinder pressure PCYLL is selected using any one of the first to third selecting methods described above, and the selected one is applied to the calculation of the output torque of the internal combustion engine and/or the calculation of an amount of heat generated in the combustion chamber. Accordingly, detection accuracy especially of the low side in-cylinder pressure PCYLL can be enhanced, thereby improving calculation accuracy of the output torque and/or the generated heat amount. In addition, if the internal combustion engine has a mechanism for changing an operation phase of the intake valve and/or the exhaust valve, it possible, by using the third selecting method and changing the preset crank angle range in response to the change in the operation phase of the intake valve and/or the exhaust valve, to accurately perform the above calculation even when the operation phase of the intake valve and/or the exhaust valve is/are changed.

In this embodiment, the charge amplifier 42 and the first amplifying circuit 42 constitute the first amplifying circuit block, and the second amplifying circuit 44 and the low pass filter 45 constitute the second amplifying circuit block. Further, the ECU 60 constitutes the control operation means and the failure detecting means.

The present invention is not limited to the above-described embodiment, and various modifications may be made. For example, it is preferable that the region to be shielded with the metal thin film 100 is the region indicated with hatchings in FIG. 2. Alternatively, only the amplifying circuit unit 81, or only the amplifying circuit unit 81 and the connecting member 12 may be shielded with the metal thin film 100. With the shield of such region, noise reduction effect can be obtained. Further, since the low pass filter 45 can reduce the influence of noises to the low side in-cylinder pressure PCYLL, the shield of the metal thin film 100 may be omitted if sufficient noise reduction effect is obtained by the low pass filter 45. Further, the low pass filter 45 may be omitted if sufficient noise reduction effect is obtained by the metal thin film 100.

Further, the low pass filter 45 in the amplifying circuit unit 81 may be replaced with a band pass filter. In such case, the pass band of the band pass filter is set to a frequency range where the fuel injection noise can be eliminated (e.g., a range from 300 Hz to 500 Hz).

Further, the pressure detecting element 2 may be contained in a sensor casing made of metal, and the metal thin film 100 may be soldered with the sensor casing. Further, in the above-described failure detecting process of FIG. 11, it is determined that a failure has occurred if the in-cylinder pressure ratio RPCYL (=PCYLHX/PCYLLX) is outside the allowable range (less than the lower threshold value RTHL or greater than the upper threshold value RTHH). Alternatively, it may be determined that a failure has occurred if a difference between the high side in-cylinder pressure PCYLH and the low side in-cylinder pressure PCYLL is greater than a determination threshold value.

What is claimed is:

1. An in-cylinder pressure detecting apparatus for detecting a pressure in a combustion chamber of an internal combustion engine, said in-cylinder pressure detecting apparatus including a pressure detecting element mounted on a fuel injection device which injects fuel into said combustion chamber, and an amplifying circuit unit having an amplifying circuit which amplifies a signal output from said pressure detecting element and outputs a pressure detection signal,
wherein an in-cylinder pressure detecting unit including said pressure detecting element, said amplifying circuit unit, and a connecting member connecting said pressure detecting element with said amplifying circuit unit, is integrated with said fuel injection device, and said amplifying circuit unit is shielded with metal thin film.

2. The in-cylinder pressure detecting apparatus according to claim 1, wherein said metal thin film contains metal with high magnetic permeability.

3. The in-cylinder pressure detecting apparatus according to claim 1, wherein said amplifying circuit unit includes a first amplifying circuit block for detecting the in-cylinder pressure within a relatively high pressure range, and a second amplifying circuit block for detecting the in-cylinder pressure within a relatively low pressure range,
wherein said second amplifying circuit block includes a low pass filter or a band pass filter.

4. The in-cylinder pressure detecting apparatus according to claim 2, wherein said amplifying circuit unit includes a first amplifying circuit block for detecting the in-cylinder pressure within a relatively high pressure range, and a second amplifying circuit block for detecting the in-cylinder pressure within a relatively low pressure range,
wherein said second amplifying circuit block includes a low pass filter or a band pass filter.

5. The in-cylinder pressure detecting apparatus according to claim 3, further including failure detecting means for performing failure detection by comparing a high side in-cylinder pressure based on the pressure detection signal output from said first amplifying circuit block, with a low side in-cylinder pressure based on the pressure detection signal output from said second amplifying circuit block.

6. The in-cylinder pressure detecting apparatus according to claim 3, further including control operation means which selects one of a high side in-cylinder pressure and a low side in-cylinder pressure respectively based on the pressure detection signals output from said first and second amplifying circuit blocks,
wherein said control operation means uses the selected one of the high side in-cylinder pressure and the low side in-cylinder pressure for calculating an output torque of said engine and/or an amount of heat generated in said combustion chamber.

7. The in-cylinder pressure detecting apparatus according to claim 5, further including control operation means which selects one of a high side in-cylinder pressure and a low side in-cylinder pressure respectively based on the pressure detection signals output from said first and second amplifying circuit blocks,
wherein said control operation means uses the selected one of the high side in-cylinder pressure and the low side in-cylinder pressure for calculating an output torque of said engine and/or an amount of heat generated in said combustion chamber.

8. The in-cylinder pressure detecting apparatus according to claim 6, wherein said control operation means selects the high side in-cylinder pressure during the compression stroke and the expansion stroke of a cylinder on which said fuel injection device is mounted, while said control operation means selects the low side in-cylinder pressure during the intake stroke and the exhaust stroke of said cylinder.

9. The in-cylinder pressure detecting apparatus according to claim 6, wherein said control operation means selects the high side in-cylinder pressure when the high side in-cylinder pressure is higher than a predetermined pressure, while said control operation means selects the low side in-cylinder pressure when the high side in-cylinder pressure is equal to or lower than the predetermined pressure.

10. The in-cylinder pressure detecting apparatus according to claim 6, wherein said control operation means selects the high side in-cylinder pressure when a rotation angle of a crankshaft of said engine is within a preset range, while said control operation means selects the low side in-cylinder pressure when the rotation angle of the crankshaft is outside the preset range.
